(19) United States
(12) Patent Application Publication
(10) Pub. No.: US 2026/0328364 A1
(43) Pub. Date: Oct. 22, 2026

(54) EXTERIOR AIRCRAFT LIGHT, AIRCRAFT COMPRISING AN EXTERIOR AIRCRAFT LIGHT, AND METHOD OF MANUFACTURING AN EXTERIOR AIRCRAFT LIGHT

(71) Applicant: Goodrich Lighting Systems GmbH & Co. KG, Lippstadt (DE)

(72) Inventors: Andre Hessling-von Heimendahl, Koblenz (DE); Anil Kumar Jha, Lippstadt (DE); Carsten Pawliczek, Lippstadt (DE)

(73) Assignee: Goodrich Lighting Systems GmbH & Co. KG, Lippstadt (DE)

(21) Appl. No.: 19/654,218

(22) Filed: Apr. 21, 2026

(30) Foreign Application Priority Data
Apr. 22, 2025 (DE) 102025115445.7

(51) Int. Cl. F21S 43/20; B64D 47/06; F21S 43/14; F21S 43/27; F21W 107/30

(52) U.S. Cl. CPC F21S 43/265; B64D 47/06; F21S 43/14; F21S 43/27; B64D 2203/00; F21W 2107/30

(57) ABSTRACT

An exterior aircraft light comprises at least one light source and a light transmissive dome-shaped cover, arranged over the at least one light source. The dome-shaped cover is made of silicone. The dome-shaped cover is an optically effective element for shaping a light output of the exterior aircraft light. An outer face of the dome-shaped cover, facing away from the at least one light source, is an outermost portion of the exterior aircraft light, which is exposed to an aircraft environment and from which the light output of the exterior aircraft light is emitted in operation.

### CROSS-REFERENCE TO RELATED APPLICATIONS

This application claims priority to, and the benefit of, DE Application No. 102025115445.7, entitled “EXTERIOR AIRCRAFT LIGHT, AIRCRAFT COMPRISING AN EXTERIOR AIRCRAFT LIGHT, AND METHOD OF MANUFACTURING AN EXTERIOR AIRCRAFT LIGHT,” filed Apr. 22, 2025, which is hereby incorporated by reference in its entirety for all purposes.

### FIELD

The present invention is in the field of exterior aircraft lighting. In particular, the present invention is in the field of exterior aircraft lights that are provided for passive visibility of the aircraft.

### BACKGROUND

Almost all aircraft are equipped with exterior aircraft lights. In particular, exterior aircraft lights for passive visibility make up an important part of the exterior aircraft lighting of most aircraft. For example, most aircraft are equipped with white flashing anti-collision lights, red flashing anti-collision lights, often also referred to as beacon lights, red, green and white navigation lights, etc. These lights are provided for attracting attention to the aircraft and for allowing observers to deduce the flight direction of the aircraft. Many of these exterior aircraft lights are considered safety-critical and are required by applicable regulations, such as the Federal Aviation Regulations (FAR). Exterior aircraft lights add weight to the aircraft, pose restrictions on the aircraft design in terms of its aerodynamics, and require, inter alia due to erosion, a significant amount of maintenance, leading to extended downtimes of the aircraft. Presently used exterior aircraft lighting systems are not fully satisfactory.

Accordingly, it would be beneficial to provide an improved exterior aircraft light that may be produced and maintained more easily and more cost-efficiently than the presently employed exterior aircraft lights.

### SUMMARY

Exemplary embodiments of the invention include an exterior aircraft light that comprises at least one light source and a light transmissive dome-shaped cover, which is arranged over the at least one light source. The dome-shaped cover is made of silicone and has a shape that provides an optical function for forming light that is emitted by the at least one light source into a light output of the exterior aircraft light. An outer face of the dome-shaped cover, facing away from the at least one light source, is an outermost portion of the exterior aircraft light. In other words, an exterior aircraft light according to an exemplary embodiment of the invention does not comprise a further protective cover that is arranged over of the dome-shaped cover. As a result, the dome-shaped cover constitutes the outermost surface of the exterior aircraft light, which is exposed to an aircraft environment and from which the light output of the exterior aircraft light is emitted in operation.

Exemplary embodiments of the invention also include a method of manufacturing an exterior aircraft light, wherein the method includes: providing at least one light source on a support structure; arranging a dome-shaped cover, made of silicone, over the at least one light source, wherein the dome-shaped cover is an optically effective element for shaping a light output of the exterior aircraft light, and wherein an outer face of the dome-shaped cover, facing away from the at least one light source, is an outermost surface of the exterior aircraft light, which is exposed to an aircraft environment and from which the light output of the exterior aircraft light is emitted in operation.

In an exterior aircraft light according to an exemplary embodiment of the invention, the dome-shape cover, which is made of silicone, provides the outermost portion of the exterior aircraft light, which is exposed to an aircraft environment. In this way, the dome-shaped cover protects the at least one light source from adverse environmental influences, including, but not being restricted to, impinging air streams, water, moisture, dust, UV radiation, de-icing fluids, hydraulic fluids, etc.. Simultaneously, the dome-shape cover provides an optically effective element that shapes a light output of the exterior aircraft light.

In other words, the dome-shape cover of an exterior aircraft light according to an exemplary embodiment of the invention may replace at least two components of a conventional exterior aircraft light, namely at least an outer cover and a separate optical element, such as a lens, which is provided for shaping the light output of the exterior aircraft light. It is possible that an exterior aircraft light according to an exemplary embodiment of the invention does not require additional sealing, fasteners and/or secondary optics for producing an appropriate light output.

Silicone is easy to process/to mold and has been found to provide the desired optical and mechanical properties for forming the dome-shape cover of an exterior aircraft light according to an exemplary embodiment of the invention. It further has been found that the erosion of a dome-shape cover, made of silicone, is low. In particular, as compared to previously used materials for the outermost parts of exterior aircraft lights, such as borosilicate glass, erosion may be significantly reduced and cracking of the cover may be prevented.

As a result, the effort and costs, associated with the manufacture and maintenance of an exterior aircraft light according to an exemplary embodiment, may be significantly reduced, as compared to those of a conventional exterior aircraft light. Also, with a reduced part count and the use of a dome-shaped cover made of silicone, significant weight savings may be achieved.

In an embodiment, the dome-shaped cover is made of an optical silicone, in particular of a transparent silicone. The dome-shaped cover may, for example, be made of liquid silicone rubber (LSR), in particular an injection moldable liquid silicone rubber (LSR). Further in particular, the dome-shaped cover may be made from an optical clear liquid silicone rubber, in particular a liquid silicone rubber that has a transmission of at least 90% across the entire spectrum of visible light. A particular, but not restricting, example of an exemplary kind of silicone is “Dow Corning® MS-0002 Moldable Silicone”.

The dome-shaped cover is an optically effective element for shaping the light output of the exterior aircraft light. In an embodiment, the dome-shaped cover has a shape that is capable of transforming a source-side light intensity distribution, as it is emitted by the at least one light source, into an output light intensity distribution, which is emitted by the exterior aircraft light. The source-side light intensity distribution may be provided directly from the at least one light source or may be modified by interposed optical element(s), such as one or more lenses and/or one or more reflectors and/or one or more shutters, before the transformation into the output light intensity distribution takes place at the dome-shaped cover.

In an embodiment, a wall thickness of the dome-shaped cover varies along its extension over the at least one light source, resulting in varying optical properties along the extension.

In an embodiment, the wall thickness of the dome-shaped cover may be in the range of between 1.5 mm and 4.5 mm. A wall thickness in this range has been found as well-suited for providing the desired optical properties as well as suitable strength and rigidity of the dome-shaped cover. The stated range for the wall thickness has been found to be particularly suitable for airplane applications. In order to adapt to the different aerodynamics in case of helicopters, the wall thickness of the dome-shaped cover may be 50% larger, in case the exterior aircraft light is configured for being mounted to a helicopter.

In an embodiment, the dome-shaped cover has a non-spherical shape on at least one of its inner surface and its outer surface for providing a desired optical effect and, thus, a desired light output of the exterior aircraft light.

In an embodiment, the at least one light source is an at least one LED. LEDs provide suitable, reliable and cost-efficient light sources for exterior aircraft lights.

In an embodiment, the exterior aircraft light comprises a plurality of light sources. The plurality of light source may include light sources emitting light having different colors.

In an embodiment, the exterior aircraft light is configured to emit light having different colors into different angular sectors extending from the exterior aircraft light. The exterior aircraft light may comprise at least one shutter for separating the portions of light that are emitted into the different angular sectors from each other.

In an embodiment, the dome-shaped cover of the exterior aircraft light extends at least over a quarter of a sphere, i.e. over a solid angle of π, as seen from the position of the light source/as seen from a center of a plurality of light sources, of π. The dome-shaped cover may in particular extend over a solid angle of between π and 2π. An exterior aircraft light that is equipped with such a dome-shaped cover is able to provide a light output having a large angular range, in particular a light output having an angular range of between 90° and 180° in a first dimension and an angular range of up to 180° in a second dimension. Light outputs having a large angular range are desirable for various types of exterior aircraft lights, such as aircraft navigation lights and aircraft anti-collision lights.

In an embodiment, the exterior aircraft light is an anti-collision light that is configured to emit white light flashes and/or red light flashes as an anti-collision light output. An exterior aircraft light that emits white light flashes may also be referred to as a white strobe anti-collision light. An exterior aircraft light that emits red light flashes may also be referred to as an aircraft beacon light. The exterior aircraft light may be a tail anti-collision light or a forward anti-collision light. The exterior aircraft light may also be a combined forward and rearward anti-collision light that is configured for being mounted to a lateral portion of an aircraft, for example to a lateral portion of an aircraft wing or to a lateral portion of a horizontal stabilizer of an aircraft. The exterior aircraft light may also be a fuselage-mounted anti-collision light, in particular a red-flashing beacon light that is configured to be mounted to a top portion or a bottom portion of an aircraft fuselage.

In an embodiment, the exterior aircraft light is a navigation light, in particular a tail navigation light that is configured to emit a white navigation light output or a forward navigation light that is configured to emit a red navigation light output or a green navigation light output. The exterior aircraft light may also be a combined forward and rearward navigation light that is configured to emit a red or green navigation light output into a forward sector and that is configured to emit a white navigation light output into a rearward sector.

In an embodiment, the exterior aircraft light is a combined anti-collision and navigation light that is configured for emitting both, an anti-collision light output and a navigation light output.

The combined anti-collision and navigation light may be a tail anti-collision and navigation light that emits the light outputs of a tail anti-collision light and of a tail navigation light, as they have been described before.

The combined anti-collision and navigation light may also be a forward anti-collision and navigation light that emits the light outputs of a forward anti-collision light and of a forward navigation light, as they have been described before.

In a further embodiment, the combined anti-collision and navigation light may be a super combined anti-collision and navigation light that is configured for emitting the light output of a forward anti-collision light, at least part of the light output of a tail anti-collision light, the light output of a forward navigation light, and at least part of the light output of a tail navigation light.

In an embodiment, the dome-shaped cover is able to sustain impinging air streams, having air speeds of up to 500 km/h, without collapsing. It can also be said that the dome-shaped cover is able to withstand/endure/tolerate/bear impinging air streams with air speeds of up to 500 km/h. In particular, in an embodiment, the dome-shaped cover is able to sustain impinging air streams with air speeds of up to 500 km/h, without deforming by more than 0.5 mm. It has been found that, when the dome-shaped cover does not deform by more than 0.5 mm, the optical properties of the dome-shaped cover are maintained to a high degree, such that the alteration of the light output of the exterior aircraft light is acceptable/tolerable. Accordingly, in spite of the presence of impinging air streams and in spite of the non-rigid nature of the silicone of the dome-shaped cover, a good solution for exterior aircraft lights may be achieved with exemplary embodiments of the invention.

An exterior aircraft light according to an exemplary embodiment of the invention, comprising a dome-shaped cover made of silicone, as described herein, may be mounted in a rearward facing position of an aircraft. In such a position, the dome-shaped cover is not exposed to the impinging air stream, when the aircraft is in flight, and the silicone of the dome-shaped cover is not exposed to critical aerodynamic stresses. Accordingly, the exterior aircraft light may be well suited to be mounted in a rearward facing position, irrespective of whether the aircraft is a comparably fast commercial passenger airplane or a comparably slow recreational airplane or a helicopter.

An exterior aircraft light according to an exemplary embodiment of the invention, comprising a dome-shaped cover made of silicone, as described herein, may also be mounted in a forward facing position or a partially forward facing position of an aircraft, such as on a forward facing structure of an aircraft or on a lateral side of an aircraft. It has been found that the exterior aircraft light is particularly suitable for such a position in aircraft having cruising speeds that do not exceed 500 km/h. At impinging air streams of not more than 500 km/h, the dome-shaped cover may be designed of silicone and may be designed such that the silicone provides good optical properties at sufficient rigidity. Accordingly, forward facing exterior aircraft lights/partially forward facing exterior aircraft lights according to exemplary embodiments of the invention are particularly suitable for smaller, comparably slow airplanes, such as recreational airplanes, and particularly suitable for helicopters.

In an embodiment, a Shore A hardness of the dome-shaped cover is between 50 and 90, in particular between 60 and 80. In an embodiment, the dome-shaped cover is made of silicone having a Shore A hardness of between 50 and 90, in particular a Shore A hardness of between 60 and 80. A dome-shaped cover having a Shore A hardness in the range of between 50 and 90, in particular a Shore A hardness in the range of between 60 and 80, has been found as well-suited for providing a good trade-off between moldability, optical properties, rigidity, and erosion-resistance of the exterior aircraft light. It has, in particular, been found to be well-suited for withstanding the mechanical loads generated by impinging airstreams, when the exterior aircraft light is mounted on an aircraft.

In an embodiment, the dome-shaped cover is spaced apart from the at least one light source, so that the dome-shaped cover does not contact the at least one light source. Instead, an empty space may be formed between the at least one light source and the dome-shaped cover. In consequence, the dome-shaped cover and the at least one light source may be provided, installed and exchanged independently of each other. As a result, a comparably easy manufacturing and maintenance of the exterior aircraft light may be achieved.

The empty space between the at least one light source and the dome-shaped cover may be filled with a gas, in particular with air. In an alternative embodiment, a vacuum or near vacuum may be provided in the empty space.

In an embodiment, the exterior aircraft light further comprises a mechanical support structure, supporting the at least one light source and the dome-shaped cover.

The support structure may include a light source support, for example a circuit board, in particular a printed circuit board, which is configured for supporting the at least one light source. The light source support may comprise conductive paths for supplying electric energy to the at least one light source.

The light source support may further support additional components of the exterior aircraft light, in particular at least one sensor for detecting the temperature and/or the light output of the at least one light source.

In an embodiment, the support structure further comprises a housing, and the light source support is mounted to the housing. The dome-shaped cover may be supported by the housing or by the light source support or jointly by the housing and the light source support. The housing may house various components of the exterior aircraft light, in particular electronics components of the exterior aircraft light. For example, the power circuitry and/or the LED driver circuitry and/or the control circuitry of the exterior aircraft light may be arranged in the housing.

In an embodiment, the dome-shaped cover is configured to engage with the support structure. In particular, the dome-shaped cover may be configured for being mounted and fixed to the support structure.

In an embodiment, a circumferential outer portion of the dome-shaped cover is shaped to engage with the support structure in a form-fit engagement. The form-fit engagement may allow for mounting and fixing the dome-shaped cover to the support structure in an effective and reliable manner. The circumferential outer portion of the dome-shaped cover may in particular comprise a collar that extends around a platform portion of the support structure, in order to establish the form-fit engagement between the dome-shaped cover and the support structure. The form-fit engagement may allow for securely fixing the dome-shaped cover to the support structure.

A method of manufacturing an exterior aircraft light according to an exemplary embodiment of the invention may include mounting the dome-shaped cover to the support structure by establishing a form-fit engagement between the dome-shaped cover and the support structure. The collar may, in particular, include an undercut structure that is configured to form-fittingly engage with the support structure for fixing the dome-shaped cover to the support structure. The undercut structure may provide an effective form-fit engagement that allows for securely fixing the dome-shaped cover to the support structure.

In an embodiment, the dome-shaped cover comprises at least one positioning protrusion, extending towards the support structure for aligning the dome-shaped cover with the support structure. When the dome-shaped cover is arranged on the support structure, the at least one positioning protrusion may in particular extend into at least one corresponding positioning opening that is formed in the support structure. In such an embodiment, the at least one positioning protrusion and the at least one corresponding opening may form a poke-yoke-key, defining the orientation of the dome-shaped cover with respect to the support structure. Providing such well-defined orientation of the dome-shaped cover with respect to the support structure may allow for ease of assembly and may allow for reliably defining the light output that is emitted by the exterior aircraft light in operation.

In a further embodiment, the dome-shaped cover may comprise a plurality of positioning protrusions. A corresponding number of positioning openings may be formed in the support structure.

The plurality of positioning protrusions and the corresponding positioning openings may be formed and arranged in a configuration that allows for the dome-shaped cover to be arranged on the support structure only in a single, predefined orientation, which results in a desired light output of the exterior aircraft light.

The positioning opening(s) may be provided in the light source support, and the positioning protrusion(s) of the dome-shaped cover may extend into the light source support. This may allow for a particularly well-defined positional relationship between the dome-shaped cover and the at least one light source.

In an embodiment, the dome-shaped cover has rotational symmetry with respect to a central axis. The light source support may extend perpendicular to the central axis. The central axis may be a central axis of the exterior aircraft light. The at least one light source may be arranged on and/or centered with respect to the central axis.

In an embodiment, the exterior aircraft light further comprises a fixing mechanism that enables a particularly secure fixation/an enhanced fixation of the dome-shaped cover to the support structure. The fixing mechanism may be a clamping mechanism that urges the dome-shaped cover to the support structure by clamping. The fixing mechanism may complement the form-fit engagement, as described herein, for a particular strong coupling between the dome-shaped cover and the support structure. The fixing mechanism/clamping mechanism may in particular extend around an upper portion and/or a side portion of support structure.

In an embodiment, the fixing mechanism includes a circumferential tension band, extending along a circumferential outer portion of the dome-shaped cover and the support structure. The fixing mechanism may further include a tightening mechanism that allows for tightening the tension band, in order to provide for a particularly tight fixation of the dome-shaped cover to the support structure with the tension band.

The circumferential tension band may extend along a substantial portion, for example along at least 80% or at least 90%, of the circumferential outer portion of the dome-shaped cover and the support structure.

The circumferential tension band may be made from metal or another suitable material.

The tightening mechanism may include a screw that extends through brackets that are attached to opposing ends of the circumferential tension band. In such a tightening mechanism, the tension band may be tightened by tightening the screw.

A fixing mechanism comprising a clamping mechanism and, in particular, a tightening mechanism may allow for fixing the dome-shaped cover to the support structure in a particularly strong and reliable manner.

A method of manufacturing an exterior aircraft light according to an exemplary embodiment of the invention may additionally include fixing the dome-shaped cover to the support structure by clamping the dome-shaped cover to the support structure using the clamping mechanism, in particular by tightening a screw of a tightening mechanism of the clamping mechanism.

In further embodiments, the tightening mechanism may include a lever and/or a buckle for tightening the tension band.

In an embodiment, the dome-shaped cover comprises at least one sealing protrusion. The at least one sealing protrusion may extend from a support-facing surface of the dome-shaped cover towards the support structure.

In an embodiment, the sealing protrusion is provided as a circumferential sealing lip. The circumferential sealing lip may extend from a circumferential outer portion of the dome-shaped cover towards the support structure.

The sealing protrusion may, in particular, extend towards the platform portion of the support structure. The platform portion of the support structure may be the outer peripheral portion of the light source support or the outer peripheral portion of the housing.

The sealing effect of the at least one sealing protrusion may be established or enhanced by tightening the fixing mechanism, in particular by tightening a circumferential tension band that extends along a circumferential outer portion of the dome-shaped cover and the support structure, as it has been described before. The fixing mechanism may press the at least one sealing protrusion against the support structure.

Exemplary embodiments of the invention also include an aircraft comprising at least one exterior aircraft light according to an exemplary embodiment of the invention.

In an embodiment, the aircraft comprises a rearward-facing exterior aircraft light according to an exemplary embodiment of the invention, which faces backwards and which is arranged at a rear portion of the aircraft, where it is not exposed to significant impinging airstreams when the aircraft is in flight.

In an embodiment, the aircraft has a cruising speed of less than 500 km/h and the aircraft comprises a forward-facing exterior aircraft light according to an exemplary embodiment of the invention or a combined forward-facing and rearward-facing exterior aircraft light according to an exemplary embodiment of the invention. The forward-facing exterior aircraft light or combined forward-facing and rearward-facing exterior aircraft light may be mounted to front or to a lateral side of the aircraft. It may also be arranged to an upper portion of the fuselage of the aircraft or to a lower portion of the fuselage of the aircraft. At the cruising speed of the aircraft of less than 500 km/h, the dome-shaped cover of the exterior aircraft light is capable of withstanding impinging airstreams without collapsing, in particular without being deformed by more than 0.5 mm, while providing good optical properties.

In an embodiment, the aircraft is an airplane. The aircraft may also be a helicopter.

### BRIEF DESCRIPTION OF THE DRAWINGS

Further exemplary embodiments of the invention are described in detail with respect the accompanying drawings, wherein:

FIG. 1 shows a cross-sectional view of an exterior aircraft light according to an exemplary embodiment of the invention;

FIG. 2 shows a perspective view of a support structure of the exterior aircraft light depicted in FIG. 1;

FIG. 3 shows a cross-sectional view of a dome-shaped cover of an exterior aircraft light according to an exemplary embodiment of the invention;

FIG. 4 shows a perspective view of the exterior aircraft light depicted in FIG. 1;

FIG. 5 shows a schematic top view of an aircraft according to an exemplary embodiment of the invention, which is an airplane and which is equipped with a plurality of exterior aircraft lights according to exemplary embodiments of the invention;

FIG. 6 shows a schematic top view of another aircraft according to an exemplary embodiment of the invention, which is in airplane and which is equipped with a plurality of exterior aircraft lights according to exemplary embodiments of the invention; and

FIG. 7 shows a schematic top view of another aircraft according to an exemplary embodiment of the invention, which is a helicopter and which is equipped with a plurality of exterior aircraft lights according to exemplary embodiments of the invention.

### DETAILED DESCRIPTION

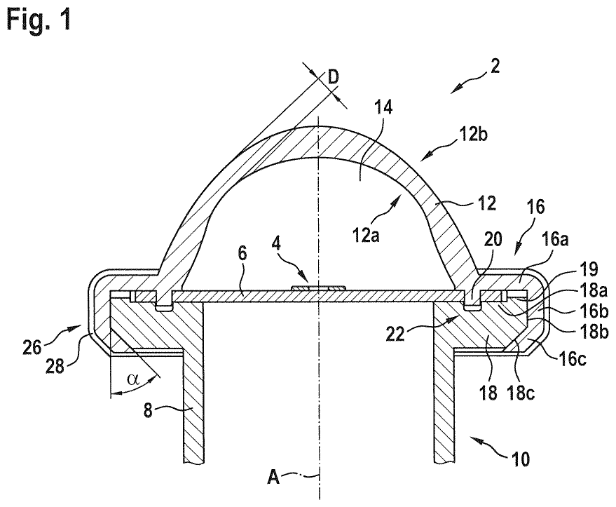

FIG. 1 shows a cross-sectional view of an exterior aircraft light 2 according to an exemplary embodiment of the invention.

The exterior aircraft light 2 comprises at least one light source 4, which is arranged on and mounted to a light source support 6, such as a circuit board 6. The at least one light source 4 may be at least one LED.

The exterior aircraft light 2 may comprise a plurality of light sources 4, in particular a plurality of light sources 4 emitting light of different colors. These colors may in particular include red, green and/or white. The plurality of light sources 4 may be a plurality of LEDs.

The exterior aircraft light 2 may be configured to emit light having different colors into different angular sectors extending from the exterior aircraft light 2. The exterior aircraft light 2 may comprise at least one shutter, which is not depicted in FIG. 1, for separating the portions of light that are emitted into the different angular sectors from each other.

The light source support 6 is attached to a housing 8. The light source support 6 is in particular arranged on a platform portion 18 of the housing 8. The housing 8 is arranged on a backside of the light source support 6, i.e. on a side of the light source support 6 that is opposite to the side of the light source support 6 on which the at least one light source 4 is arranged.

For aligning the light source support 6 with respect to the platform portion 18, a circumferential rim 19 is formed along the outer circumference of the platform portion 18.

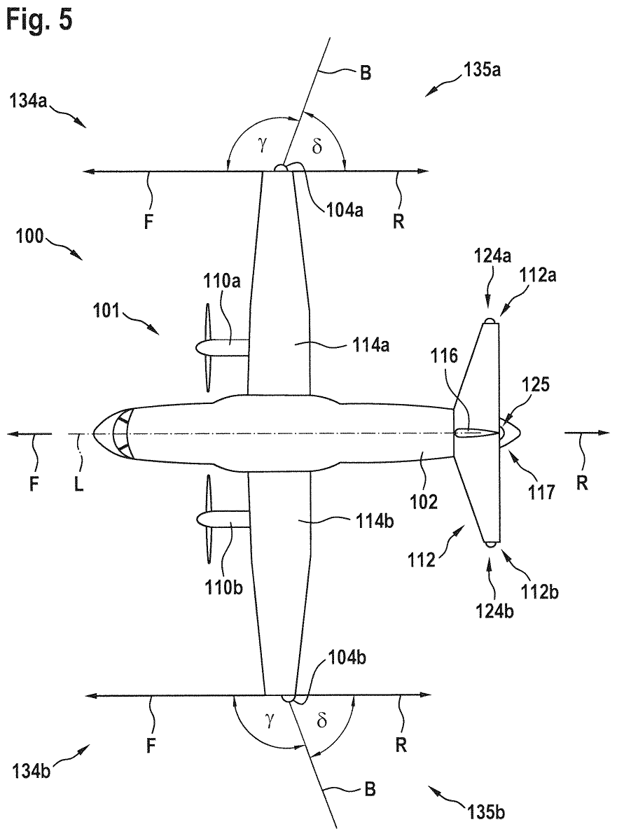

The light source support 6 and the housing 8 form, in combination, a support structure 10 of the exterior aircraft light 2. The housing 8 may be mounted to an aircraft 100 (see FIGS. 5 to 7), which is not depicted in FIG. 1.

The exterior aircraft light 2 further comprises a dome-shaped cover 12, which is arranged over the at least one light source 4. The dome-shaped cover 12 is light transmissive, allowing light, which is emitted from the at least one light source 4, to pass through the dome-shaped cover 12 for providing a light output of the exterior aircraft light 2. The dome-shaped cover 12 can be light transmissive everywhere. It is also possible that the dome-shaped cover 12 has light transmissive portions and non-light transmissive portions, i.e. that the dome-shaped cover 12 is partially light transmissive. Such a dome-shaped cover 12 is still considered light transmissive, because it allows for the exterior aircraft light 2 to emit the desired light output.

The support structure 10 and the dome-shaped cover 12 may have rotational symmetry with respect to an axis A, which extends basically perpendicular through the light source support 6. The at least one light source 4 may be arranged on the axis A. In case the exterior aircraft light 2 comprises a plurality of light sources 4, the plurality of light sources 4 may be arranged around/centered on the axis A.

The at least one light source 4, or a configuration comprising a plurality of light sources 4, may exhibit rotational symmetry with respect to the axis A.

The dome-shaped cover 12 does not contact the at least one light source 4. Instead, the dome-shaped cover 12 is spaced apart from the at least one light source 4. In consequence, the exterior aircraft light 2 comprises an empty space 14 between the light source support 6 and the at least one light source 4 on the one hand and the dome-shaped cover 12 on the other hand.

The empty space 14 may be filled with a gas, such as air. In an alternative configuration, a vacuum or near-vacuum may be provided in the empty space 14.

The dome-shaped cover 12 is made of silicone, in particular of an optical silicone, more particularly of a transparent silicone. The dome-shaped cover 12 may, for example, be made of liquid silicone rubber (LSR), in particular made of an injection moldable liquid silicone rubber (LSR). The dome-shaped cover may in particular be made from an optical clear liquid silicone rubber and may have a transmission of at least 90% across the entire spectrum of visible light. A particular example of an exemplary kind of silicone is Dow Corning® MS-0002 Moldable Silicone.

The dome-shaped cover 12 can be molded from silicone. The dome-shaped cover 12 can be fully made of silicone, in particular molded completely from silicone, more in particular molded completely from silicone in a single molding step. In this way, a very high material homogenity of the dome-shaped cover 12 may be achieved and highly beneficial optical properties, such as very low refractions within the material, may be achieved. It is also possible that the silicone is molded around one or more reinforcing elements/structural support elements, which may be provided for enhancing the stability of the dome-shaped cover 12. It is further possible that the some agent, such as a stability-enhancing agent, may be admixed to the silicone and that the dome-shaped cover 12 is made, in particular molded, from such mixture. For all of the above embodiments, the dome-shaped cover 12 is considered to be made of silicone.

The dome-shaped cover 12 is formed as an optically effective element, which is configured to shape a light output of the exterior aircraft light 2 from the light that is emitted by the at least one light source 4.

The dome-shaped cover 12 may, for example, have a shape that provides an optical function, such as the function of a lens.

The dome-shaped cover 12 may have a non-spherical shape on at least one of its inner surface 12a and its outer surface 12b.

The wall thickness D of the dome-shaped cover 12 may, for example, vary along its extension over the at least one light source 4, resulting in varying optical properties along the extension.

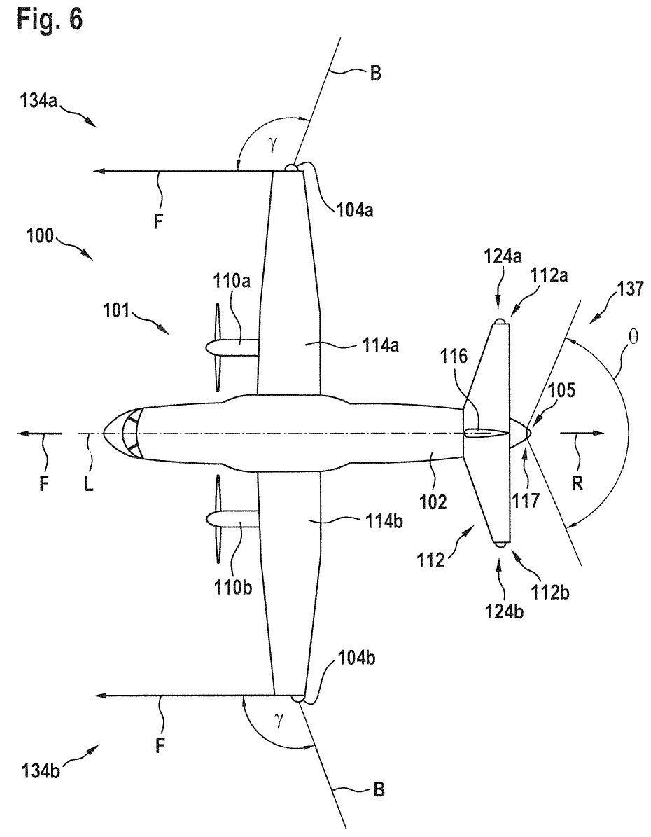

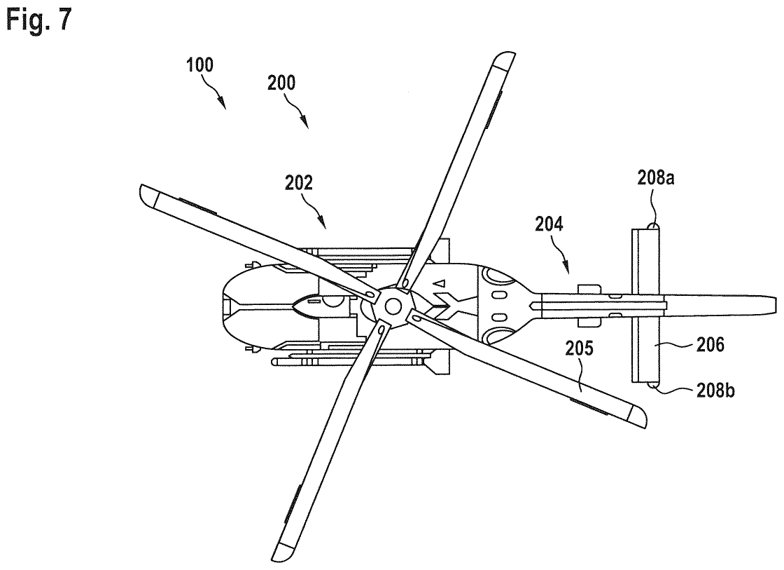

The wall thickness D of the dome-shaped cover 12 may, for example, be in the range of between 1.5 mm and 4.5 mm. This may in particular be the case if the exterior aircraft light 2 is intended to be mounted to an airplane 101, as it is depicted in FIGS. 5 and 6. In case the exterior aircraft light 2 is intended to be mounted to a helicopter 200 (see FIG. 7), the wall thickness of the dome-shaped cover may be 50% larger, in order to adapt to the different aerodynamics of helicopters 200.

The outer surface 12b of the dome-shaped cover 12, i.e. the surface 12b of the dome-shaped cover 12 that faces away from the at least one light source 4, is an outermost portion of the exterior aircraft light 2. This outermost portion of the exterior aircraft light 2 is exposed to the environment, in particular to an aircraft environment, when the exterior aircraft light 2 is mounted to an aircraft 100.

In other words, the outer surface 12b of the dome-shaped cover 12 constitutes an outer surface of the exterior aircraft light 2. An exterior aircraft light 2 according to an exemplary embodiment of the invention does, in particular, not comprise an additional protective cover, arranged outside/over the dome-shaped cover 12 for covering and protecting the dome-shaped cover 12 from the environment. It is not required that all of the outer surface 12b of the dome-shaped cover 12 is exposed to the outside environment of the aircraft 100. As is apparent from the embodiments described herein, some parts of the dome-shaped cover 12 may be used for fixing the dome-shaped cover 12 to the support structure 10 and may, in this capacity, be placed immediately adjacent the support structure 10 and/or may be covered by parts of the fixing mechanism. However, the part of the dome-shaped cover 12, through which the light output of the exterior aircraft light 2 is emitted, is an outermost part of the exterior aircraft light 2.

The dome-shaped cover 12 is designed to sustain/withstand impinging air streams at speeds of up to 500 km/h without collapsing. In particular, the dome-shaped cover 12 may be designed to sustain/withstand impinging air streams at speeds of up to 500 km/h, without being deformed by the impinging air streams by more than 0.5 mm.

This ability of the dome-shaped cover 12 to cope with impinging air streams allows for mounting an exterior aircraft light 2 according to an exemplary embodiment of the invention to a front face or to a lateral side face of an aircraft 100, as long as the speed of the impinging air streams does not exceed 500 km/h. In consequence, an exterior aircraft light 2 according to an exemplary embodiment of the invention may be mounted to a front face or to a lateral side face of an aircraft 100 that is configured for flying not faster than 500 km/h with respect to the surrounding air.

An exterior aircraft light 2 according to an exemplary embodiment of the invention may further be mounted to a rear face of an aircraft 100, even to a rear face of an aircraft 100 that is configured for flying faster than 500 km/h, because exterior aircraft lights 2 mounted to rear faces of aircraft 100 are not exposed to fast impinging air streams, even when the aircraft 100 is in flight.

In order to be able to withstand the impinging air streams, the Shore A hardness of the dome-shaped cover 12 may, for example, be in a range of between 50 and 90, in particular in a range of between 60 and 80. The dome-shaped cover 12 may be made of silicone having a Shore A hardness of between 50 and 90, in particular a Shore A hardness of between 60 and 80.

For mounting and fixing the dome-shaped cover 12 to the support structure 10, the dome-shaped cover 12 is configured to engage with the support structure 10.

In particular, a circumferential outer portion 16 of the dome-shaped cover 12 is shaped for engaging with the support structure 10 in a form-fit engagement. As depicted in FIG. 1, the circumferential outer portion 16 of the dome-shaped cover 12 is shaped as a circumferential collar that extends around a platform portion 18 of the support structure 10, in order to establish a form-fit engagement between the circumferential outer portion 16 of the dome-shaped cover 12 and the platform portion 18 of the support structure 10.

The circumferential outer portion 16 may comprise a first part 16a that extends along an upper portion 18a of the platform portion 18, which is oriented perpendicular to the axis A; a second part 16b that extends basically perpendicular to the first part 16a parallel to the axis A, along an outer circumferential portion 18b of the platform portion 18; and a third part 16c, the extends at an acute angle α from an end of the second part 16b, along a correspondingly inclined lower portion 18c of the platform portion 18.

The third part 16c may, for example, be inclined with respect to the second part 16b by an angle α in the range of between 30° and 60°, in particular by an angle of 45°.

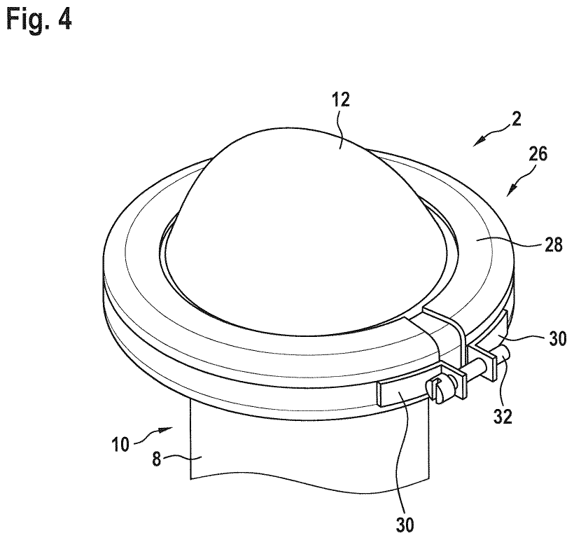

FIG. 1 further depicts a circumferential tension band 28 that extends along and encloses a circumferential outer portion of the dome-shaped cover 12 and the support structure 10. The circumferential tension band 28 may extend around the first part 16a, the second part 16b, and the third part 16c of the circumferential outer portion 16. The circumferential tension band 28 is part of a fixing mechanism 26 for securely fixing the dome-shaped cover 12 to the support structure 10. The fixing mechanism 26 will be described in more detail further below with reference to FIG. 4.

The dome-shaped cover 12 further comprises at least one positioning protrusion 20, which is provided for aligning the dome-shaped cover 12 with respect to the support structure 10. The at least one positioning protrusion 20 extends from a lower surface of the dome-shaped cover 12, facing the support structure 10, towards the support structure 10.

For aligning the dome-shaped cover 12 with respect to the support structure 10, the at least one positioning protrusion 20 extends into at least one corresponding positioning opening 22 that is formed in the support structure 10, in particular formed in the light source support 6.

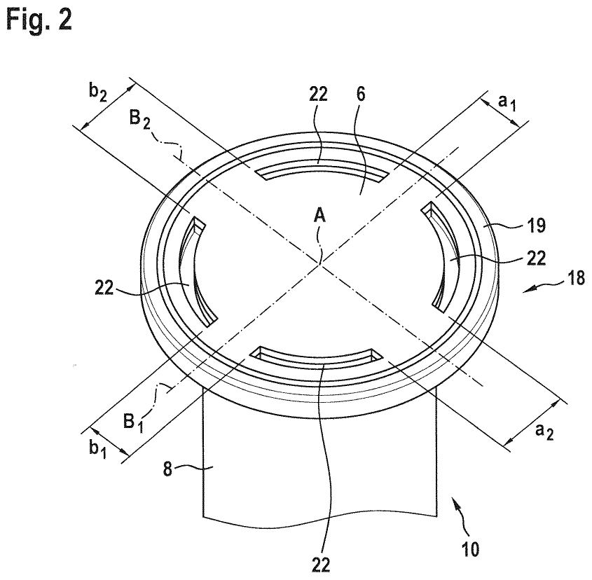

FIG. 2 depicts a perspective view of the support structure 10 of the exterior aircraft light 2 of FIG. 1, including the housing 8 with the platform portion 18 and the light source support 6. The dome-shaped cover 12 and the at least one light source 4 are not shown in FIG. 2.

In the configuration depicted in FIG. 2, four positioning openings 22, which are configured for receiving corresponding positioning protrusions 20 of the dome-shaped cover 12, are formed in the light source support 6 and the platform portion 18 of the housing 8 (cf. FIG. 1).

Each of the positioning openings 22 has an arcuate shape, in particular the shape of a segment of a circle, which is centered around the axis A of the support structure 10. The positioning openings 22 are symmetrically identical, i.e. mirror identical, with respect to two mirror axes B₁, B₂, extending perpendicular to each other on the upper surface of the light source support 6.

The distances a₁, b₁ between adjacent positioning openings 22 across the first mirror axis B₁ may differ from the distances a₂, b₂ between adjacent positioning openings 22 across the second mirror axis B₂. In combination with correspondingly formed positioning protrusions 20 at the dome-shaped cover 12, such a configuration allows for mounting the dome-shaped cover 12 to the support structure 10 only in a predefined orientation, but not in an orientation that is rotated by 90° with respect to the predefined orientation.

In other words, in combination with the positioning protrusions 20 extending from the dome-shaped cover 12, the positioning openings 22 form a poke-yoke-key, which defines the orientation of the dome-shaped cover 12 with respect to the support structure 10 with respect to the axis A, when the dome-shaped cover 12 is mounted to the support structure 10.

Optionally, in order to restrict the possible orientations of the dome-shaped cover 12 with respect to the support structure 10 even further, the two distances a₁, b₁ between the adjacent positioning openings 22 across the first mirror axis B₁ may differ from each other and/or the two distances a₂, b₂ between the adjacent positioning openings 22 across the second mirror axis B₂ may differ from each other, too.

The number, the positions and the shapes of the positioning openings 22 depicted in FIG. 2 are only exemplary. In alternative embodiments, which are not explicitly shown in the figures, the numbers, the positions and/or the shapes of the positioning openings 22 and the corresponding positioning protrusions 20 may differ from the configuration depicted in FIG. 2.

Although not depicted in FIG. 1, at least one sealing protrusion 24 may be formed on the surface of the dome-shaped cover 12 facing the support structure 10.

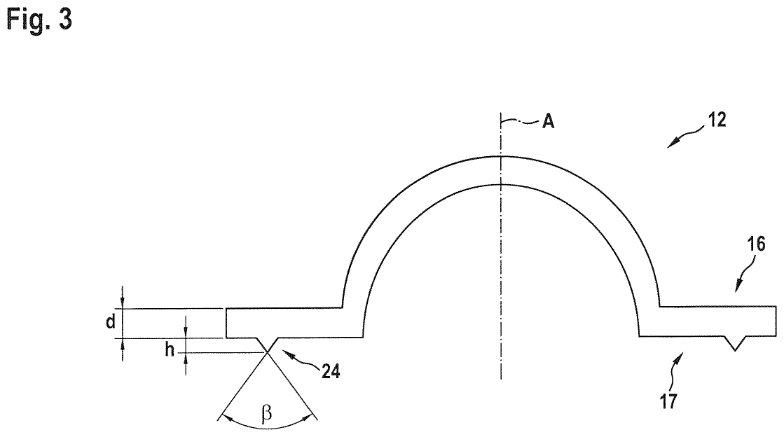

A cross-sectional view of a dome-shaped cover 12, comprising such a sealing protrusion 24, is depicted in FIG. 3. In the exemplary embodiment depicted in FIG. 3, the sealing protrusion 24 is provided as a circumferential sealing lip, extending from the lower surface 17 of the circumferential outer portion 16 of the dome-shaped cover 12, i.e. extending from the surface 17 of the circumferential outer portion 16 of the dome-shaped cover facing the support structure 10, towards the support structure 10.

When the dome-shaped cover 12 is arranged on the support structure 10, the sealing protrusion 24 extends towards the light source support 6 and/or the platform portion 18 of the support structure 10. The sealing protrusion 24 may in particular extend towards an outer peripheral portion of the light source support 6 or towards an outer peripheral portion of the housing 8, which are not depicted in FIG. 3.

While not being depicted in FIG. 3, it is understood that the dome-shaped cover 12 of FIG. 3 may also have a circumferential collar at its circumferential outer portion 16, as described above with respect to FIG. 1.

In the embodiment depicted in FIG. 3, the sealing protrusion 24 has a triangular cross-section. The angle β of the triangular cross-section may be in the range of between 50° and 70°, the angle β may in particular be 60°.

The circumferential outer portion 16 of the dome-shaped cover 12 may have a thickness d in the range of between 2 mm and 4 mm, and the sealing protrusion 24 may have a height h of approximately ⅓ of the thickness d; in other word, the sealing protrusion 24 may have a height h in the range of approximately ⅔ mm to 4/3 mm.

FIG. 4 depicts a perspective view of an exterior aircraft light 2 according to an exemplary embodiment of the invention.

The dome-shaped cover 12 of the exterior aircraft light 2, as depicted in FIG. 4, has an extension of substantially half a sphere, i.e. has an extension over a solid angle of about 2π. Such a dome-shaped cover 12 allows the exterior aircraft light to provide a light output having a large angular range, in particular an angular range of about 180° in a first dimension and an angular range of about 180° in a second dimension, orthogonal to the first dimension, in a carthesian coordinate system. It can also be said that the light output may have an angular range of 360° in a light output plane parallel to the light source support 6, and an angular range of up to 180° in a second plane that is oriented perpendicular to the first plane.

The dome-shaped cover 12 is fixed to the support structure by a fixing mechanism 26. In the exemplary embodiment depicted in FIG. 1, the fixing mechanism 26 is provided as a clamping mechanism.

The fixing mechanism 26 comprises a circumferential tension band 28, extending along and substantially enclosing a circumferential outer portion 16 of the dome-shaped cover 12 and the platform portion 18 of the support structure 10. The circumferential tension band 28 may in particular extend along a substantial portion, for example along at least 80%, of the circumferential outer portion of the dome-shaped cover 12 and the support structure 10.

Two brackets 30 are attached to opposing ends of the circumferential tension band 28. A screw 32 extends between and engages with the two brackets 30. For securely fixing the dome-shaped cover 12 to the support structure 10, the circumferential tension band 28 may be tightened by tightening the screw 32.

Alternative tightening mechanisms, such as tightening mechanisms comprising a lever and/or a buckle, which are not explicitly depicted in the figures, may be employed as well.

FIGS. 5 to 7 depict schematic top views of aircraft 100 according to exemplary embodiments of the invention, which are equipped with a plurality of exterior aircraft lights 2 according to exemplary embodiments of the invention.

FIGS. 5 and 6 depict an aircraft 100 according to an exemplary embodiment of the invention, which is a fixed wing airplane 101, comprising a fuselage 102, two fixed wings 114a, 114b, a horizontal stabilizer 112, and a vertical stabilizer 116. An engine 110a, 110b is mounted to each of the fixed wings 114a, 114b, respectively.

Exterior aircraft lights according to exemplary embodiments of the invention may also be employed in aircraft having different configurations, which are not explicitly depicted in the figures. Such aircraft may in particular include airplanes that are equipped with fewer or more than two engines.

In the exemplary embodiment depicted in FIGS. 5 and 6, a navigation light 104a, 104b is mounted to the wing tip of each of the two wings 114a, 114b, respectively.

A starboard navigation light 104a, emitting a forward navigation light output having green color, is arranged at the wing tip of the starboard or right wing 114a. A port side navigation light 104b, emitting a forward navigation light output having red color, is arranged at the wing tip of the port side or left wing 114b.

Each navigation light 104a, 104b is in particular configured to emit a red or green forward navigation light output into a forward sector 134a, 134b that extends, when looked at in a horizontal plane comprising or extending basically parallel to the wings 114a, 114b of the aircraft 100, between a forward direction F, which is oriented basically along the longitudinal axis L of the aircraft 100, and an outer boundary B over an angle γ of approximately 110°.

In the exemplary embodiment depicted in FIG. 5, each navigation light 104a, 104b is further configured to emit a white rear navigation light output into a rearward sector 135a, 135b that extends, when looked at in the above mentioned horizontal plane, between the outer boundary B and a rearward direction R, which is oriented basically along the longitudinal axis L of the aircraft 100 and opposite to the forward direction F, over an angle δ of approximately 70°

In an alternative embodiment, which is depicted in FIG. 6, the navigation lights 104a, 104b that are mounted to the tips of the wings 114a, 114b are forward navigation lights 104a, 104b, which are configured to emit only a red or green forward navigation light output into the corresponding forward sector 134a, 134a, respectively. In such a configuration, the aircraft 100 further comprises a separate rearward navigation light 105 that is configured to emit a white rear navigation light output into a rearward sector 137 that has, when looked at in the above mentioned horizontal plane, an opening angle θ of approximately 140° and that is oriented basically mirror-symmetrically with respect to the rearward direction R. In the exemplary embodiment depicted in FIG. 6, such a rearward navigation light 105 is mounted to a tail 117 of the fuselage 102.

The aircraft 100, as depicted in FIGS. 5 and 6, further comprises a plurality of anti-collision lights 124a, 124b, 125 that are configured to emit white light flashes and/or red light flashes.

In the embodiments, depicted in FIGS. 5 and 6, the anti-collision lights 124a, 124b, 125 are mounted to the horizontal stabilizer 112 of the aircraft 100.

In further embodiments that are not explicitly depicted in the Figures, the anti-collision lights 124a, 124b, 125 may be mounted to the wings 114a, 114b, in particular to the wing-tips of the wings 114a, 114b, and/or to the fuselage 102 of the aircraft, similar to the navigation lights 104a, 104b, 105. The anti-collision lights 124a, 124b, 125 may in particular be located in close vicinity/adjacent to the navigation lights 104a, 104b, 105.

The exemplary embodiment of an aircraft 100, as depicted in FIG. 5, comprises two forward anti-collision lights 124a, 124b, mounted to the opposite tips 112a, 112b of the horizontal stabilizer 112, and a rearward anti-collision light 125, mounted to the center of the rear side of the horizontal stabilizer 112. In the exemplary embodiment of FIG. 5, the anti-collision lights 124a, 124b, 125 emit white light flashes and red flashes in operation, thus assuming the functions of both white strobe anti-collision lights and red-flashing beacon lights. It is also possible that the anti-collision lights 124a, 124b, 125 are white strobe anti-collision lights and that additional red-flashing beacon lights, which are not depicted in FIG. 5, are provided on the upper portion and the lower portion of the fuselage 102 of the aircraft 100.

In the alternative embodiment depicted in FIG. 6, the anti-collision lights 124a, 124b, mounted to the tips of the horizontal stabilizer 112, are combined forward and rearward anti-collision lights 124a, 124, which are configured to emit white light flashes and/or red light flashes into a sector that extends from the forward direction F to the rearward direction R over an angle of at least 180°. In this case, it is not necessary to additionally provide a rearward anti-collision light 125.

In further embodiments, which are not explicitly shown in the figures, an aircraft 100 may comprise the anti-collision lights 124a, 124b, 125, as depicted in FIG. 5, and the navigation lights 104a, 104b, 105, as depicted in FIG. 6, or the aircraft 100 may comprise the anti-collision lights 124a, 124b, as depicted in FIG. 6, in combination with the navigation lights 104a, 104b, as depicted in FIG. 5.

An aircraft 100 according to an exemplary embodiment of the invention may also comprise combined anti-collision and navigation lights, which are configured to emit both, navigation light outputs as well as flashing anti-collision light outputs, as they have been described before with reference to the navigation lights 104a, 104b, 105 and with respect to the anti-collision lights 124a, 124b, 125.

The combined anti-collision and navigation lights may also be super combined anti-collision and navigation lights that are configured for emitting a combined light output, including the light outputs of a forward anti-collision light, of a tail anti-collision light, of a forward navigation light, and of a tail navigation light. Such super combined anti-collision and navigation lights may be arranged at the positions of the navigation lights 104a, 104b, as depicted in FIG. 5.

In the embodiments depicted in FIGS. 5 and 6, the forward navigation lights 104a, 104b and the forward anti-collision lights 124a, 124b, which are mounted to the tips of the wings 114a, 114b and to the tips 112a, 112b of the horizontal stabilizer 112, are exposed to the impinging air flow that flows over and along the wings 114a, 114b and the horizontal stabilizer 112 of the aircraft 100, when the aircraft 100 is in flight.

Exterior aircraft lights 2 according to exemplary embodiments of the invention may in particular be employed as navigation lights 104a, 104b and/or anti-collision lights 124a, 124b, which are mounted to forward facing portions or to the tips of each of the two wings 114a, 114b/of the horizontal stabilizer 112, for smaller and slower aircraft 100, in particular for aircraft 100 that are configured for cruising speeds of less than 500 km/h.

When the aircraft 100 is cruising at speeds below 500 km/h, the rigidity of the dome-shaped cover 12 of an exterior aircraft light 2 according to an exemplary embodiment of the invention is large enough to sustain the impinging air stream, without being deformed beyond acceptable limits, e.g. without being deformed by more than 0.5 mm.

The rear navigation light 105 and rear anti-collision light 125, which may be mounted to a rear side of the horizontal stabilizer 112 or to a rear side of the fuselage 102 of the aircraft 100, are not directly exposed to the impinging air stream, flowing over the aircraft 100 in flight. This correspondingly applies to exterior aircraft lights 2 that are mounted to a rear side of the wings 114a, 114b.

In consequence, exterior aircraft lights 2 according to exemplary embodiments of the invention may be employed as rear navigation lights 105 and/or as rear anti-collision lights 125 even in fast flying aircraft 100, in particular in aircraft 100 that are designed for cruising at speeds of more than 500 km/h, such as large commercial airplanes.

FIG. 7 shows a schematic top view of an aircraft 100 according to an alternative embodiment of the invention. The aircraft 100 depicted in FIG. 7 is a rotary wing aircraft or helicopter 200. The helicopter 200 has a fuselage 202 including the cabin, a tail 204, and a main rotor 205. A horizontal stabilizer 206 is attached to the tail 204 of the helicopter 200.

The horizontal stabilizer 206 is equipped with two exterior helicopter lights 208a, 208b, which are exterior aircraft lights 2 in accordance with exemplary embodiments of the invention.

The exterior helicopter lights 208a, 208b may be navigation lights 104a, 104b or anti-collision lights 124a ,124b or combined navigation and lights anti-collision lights, as they have been described before with respect to the airplanes 101 depicted in FIGS. 5 and 6.

In the exemplary embodiment depicted in FIG. 7, the exterior helicopter lights 208a, 208b are mounted to the left lateral end portion and to the right lateral end portion of the horizontal stabilizer 206, respectively. In this way, the exterior helicopter lights 208a, 208b are mounted to the most lateral stationary portions of the helicopter 200. This allows for the light output of the exterior helicopter lights 208a, 208b to be maximally un-obstructed by the fuselage 202 of the helicopter 200.

Since the cruising speed of helicopters 200 does usually not exceed 500 km/h, exterior helicopter lights 208a, 208b, which are provided as exterior aircraft lights 2 in accordance with exemplary embodiments of the invention, may be mounted to any face of the helicopter 200, including the rear faces of the horizontal stabilizer 206, but also the front faces of the horizontal stabilizer 206 and/or front, lateral and rear faces of the fuselage 202 of the helicopter 200.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention not be limited to the particular embodiment disclosed, but that the invention include all embodiments falling within the scope of the following claims.

1. An exterior aircraft light comprising:
at least one light source; and
a light transmissive dome-shaped cover, arranged over the at least one light source;
wherein the dome-shaped cover is made of silicone;
wherein the dome-shaped cover is an optically effective element for shaping a light output of the exterior aircraft light; and
wherein an outer face of the dome-shaped cover, facing away from the at least one light source, is an outermost portion of the exterior aircraft light, which is exposed to an aircraft environment and from which the light output of the exterior aircraft light is emitted in operation.

2. The exterior aircraft light according to claim 1, wherein the dome-shaped cover is able to sustain impinging air streams having air speeds of up to 500 km/h.

3. The exterior aircraft light according to claim 1, wherein the dome-shaped cover is spaced apart from the at least one light source.

4. The exterior aircraft light according to claim 1, further comprising a support structure, including a light source support, such as a circuit board,
wherein the support structure supports the at least one light source and the dome-shaped cover.

5. The exterior aircraft light according to claim 4,
wherein the dome-shaped cover is configured to engage with the support structure;
wherein a circumferential outer portion of the dome-shaped cover is in particular shaped to engage with the support structure in a form-fit engagement;
wherein the circumferential outer portion of the dome-shaped cover further in particular has a collar that extends around a platform portion of the support structure to establish the form-fit engagement.

6. The exterior aircraft light according to claim 4,
wherein the dome-shaped cover comprises at least one positioning protrusion, extending towards the support structure for aligning the dome-shaped cover with the support structure;
wherein the at least one positioning protrusion in particular extends into at least one corresponding positioning opening that is formed in the support structure;
wherein the at least one positioning protrusion and the at least one corresponding positioning opening further in particular form a poke-yoke-key, defining the orientation of the dome-shaped cover with respect to the support structure.

7. The exterior aircraft light according to claim 4, wherein the dome-shaped cover comprises at least one sealing protrusion, extending towards the support structure;
wherein the sealing protrusion is in particular a circumferential sealing lip, extending from a circumferential outer portion of the dome-shaped cover towards the support structure.

8. Th exterior aircraft light according to claim 4, further comprising a fixing mechanism, in particular a clamping mechanism, for securely fixing the dome-shaped cover to the support structure;
wherein the fixing mechanism in particular includes a circumferential tension band that extends along a circumferential outer portion of the dome-shaped cover and the support structure;
wherein the circumferential tension band more particularly extends along a substantial portion of the circumferential outer portion of the dome-shaped cover and the support structure.

9. The exterior aircraft light according to claim 1,
wherein a wall thickness (D) of the dome-shaped cover is in the range of between 1.5 mm and 4.5 mm; and/or
wherein a Shore A hardness of the dome-shaped cover is between 50 and 90, in particular between 60 and 80; and/or
wherein the dome-shaped cover is made of a transparent silicone, in particular of a transparent liquid silicone rubber.

10. The exterior aircraft light according to claim 1, wherein the dome-shaped cover extends at least over a solid angle of π, in particular over a solid angle of between π and 2π.

11. The exterior aircraft light according to claim 1, wherein the exterior aircraft light is one of:
an anti-collision light, in particular a tail anti-collision light or a forward anti-collision light or a combined forward and rearward anti-collision light;
a navigation light, in particular a tail navigation light or a forward navigation light or a combined forward and rearward navigation light;
a combined anti-collision and navigation light that combines the functionalities of an anti-collision light and a navigation light.

12. An aircraft, such as an airplane or a helicopter, comprising the at least one exterior aircraft light according to claim 1.

13. The aircraft according to claim 12,
wherein the at least one exterior aircraft light comprises a rearward-facing exterior aircraft light, wherein the rearward-facing exterior aircraft light is in particular arranged at a rear portion of the aircraft;
and/or
wherein the at least one exterior aircraft light comprises a forward-facing exterior aircraft light or a combined forward-facing and rearward-facing exterior aircraft light, wherein the forward-facing exterior aircraft light or combined forward-facing and rearward-facing exterior aircraft light is in particular mounted to a lateral side of the aircraft, and wherein the aircraft (100) has a cruising speed of less than 500 km/h.

14. A method of manufacturing an exterior aircraft light, wherein the method includes:
providing at least one light source on a support structure;
arranging a dome-shaped cover, made of silicone, over the at least one light source;
wherein the dome-shaped cover is an optically effective element for shaping a light output of the exterior aircraft light; and
wherein an outer face of the dome-shaped cover, facing away from the at least one light source, is an outermost portion of the exterior aircraft light, which is exposed to an aircraft environment and from which the light output of the exterior aircraft light is emitted in operation.

15. The method according to claim 14, further including:
mounting the dome-shaped cover to the support structure by form-fit engagement; and/or
fixing the dome-shaped cover to the support structure by clamping the dome-shaped cover to the support structure using a clamping mechanism.
